(19) United States
(12) Patent Application Publication
(10) Pub. No.: US 2005/0233110 A1
(43) Pub. Date: Oct. 20, 2005

(54) Extrusion molded product having core material

(76) Inventors: Naohisa Miyakawa, Shiroi-shi (JP); Katsuhisa Kato, Moriya-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/106,614

(22) Filed: Apr. 15, 2005

(30) Foreign Application Priority Data
Apr. 16, 2004 (JP) 2004-149777

(51) Int. Cl. B32B 3/04

(52) U.S. Cl. 428/122

(57) ABSTRACT

An extrusion molded product such as a trim, weather strip, and window molding which is used in a vehicle body opening such as a door, trunk and window of an automobile comprises a core material made of a hard synthetic resin and having a substantially U-shaped cross section, and an inner and outer peripheral coating bodies made of a soft synthetic resin and coating the core material. The inner peripheral coating body or outer peripheral coating body is provided with a pushed-in portion extending downward beyond the lower end of the core material so as to be capable of being pushed toward the inside of the core material. The pushed-in portion is provided with holding elements the outer periphery thereof. The inner peripheral coating body is melting adhered to the whole of a part of the inner periphery of the core material, and the outer peripheral coating body is melting adhered to the whole or a part of the outer periphery of the core material.

### BACKGROUND OF THE INVENTION

1. Field of the Invention

The present invention relates to an extrusion molded product having a core material, such as a trim, weather strip, window molding, etc. which is used to hold a flange portion of a vehicle body disposed in a vehicle body opening such as a door, trunk, window, etc. of an automobile.

2. Description of Prior Art

Conventionally, in order to enhance a holding force in installing an automotive trim, weather strip, window molding, etc. to a vehicle body of an automobile, a metallic core material has generally been used. In the step for manufacturing the extrusion molded product, the metallic core material has cut portions of various shapes punched in a state of a flat plane shape in cross section, a coating layer and holding portions are formed on the front and rear surfaces of the flat plate shaped core material having the cut portions by extrusion molding a material such as synthetic resin or rubber on said core material, and then the extrusion molded core material is bent so as to have a substantially U-shaped cross section, by which the extrusion molded product is manufactured.

However, there is a demand for changing the material of the core material from a metal to a hard synthetic resin to reduce the weight of the core material and to recycle it because of a growing environmental concern in recent years.

If the core material made of a hard synthetic resin is manufactured from a flat plate as in the case of the metallic core material, there arises many problems such that the core material having been bent so as to have a substantially U-shaped cross section restores itself to the original flat plate shape. Therefore, the core material of a hard synthetic resin is extrusion molded in the form of a substantially U-shaped cross section and cut portions of various shapes are formed by a punching machine, by which a core material having cut portions is formed. Thereafter, a coating body made of a soft synthetic resin is melting adhered by extrusion molding to the core material made of a hard synthetic resin and having a substantially U-shaped cross section, and a plurality of opposed holding elements are formed on the inner peripheral surface of the core material to hold a flange portion of a vehicle body opening of an automobile.

However, in order to enhance the holding property of the extrusion molded product with respect to the flange portion of a vehicle body opening of an automobile, it is necessary to surely decrease a gap between the opposed holding elements, but there arises a problem in that extrusion molding is technically very difficult to perform so that the gap is surely made narrow.

### SUMMARY OF THE INVENTION

In order to solve the above problem, it is an object of the present invention to provide an extrusion molded product which is provided with a pushed-in portion formed on an outer peripheral coating body or an inner peripheral coating body adhered to a core material having a substantially U-shaped cross section, and in which a gap between holding portions can be made very narrow and the holding portions can be firmly fixed to a flange portion of a vehicle body of an automobile by pushing in the pushed-in portion toward an inner peripheral surface of a core material having a substantially U-shaped cross section.

To attain the above-mentioned object, an extrusion molded product according to the present invention comprises a molded product body which includes a core material made of a hard synthetic resin in a substantially U-shaped cross section and having variously shaped cut portions on the sides, and an outer peripheral coating body and inner peripheral coating body made respectively of a soft synthetic resin and formed respectively on the outer and inner surface of the core material so as to cover the core material having the U-shaped cross section. Said molded product body has a pushed-in portion formed integrally with the outer peripheral coating body or the inner peripheral coating body. The pushed-in portion is formed so as to extend downward beyond the end portion of the core so as to be capable of being pushed toward the inner peripheral surface of the core material having a substantially U-shaped cross section and has a holding element formed integrally in their outer periphery.

Further, the molded product body has a holding element formed integrally on the inner peripheral coating body on the other side of the opposed sides of the core material having the U-shaped cross section. In addition, the molded product body is provided with each pushed-in portion having a holding portion which extends downward from each inner peripheral coating body on the opposed sides of the core material having the U-shaped cross section. Furthermore, the molded product body is provided with a pushed-in portion which extends downward from each inner peripheral coating body on the opposed sides of the core material having the U-shaped cross section in the form of a curved shape connected to each other and has holding elements formed in the outer periphery of the pushed-in portion. Because the core material can be produced by the extrusion molding, the thickness of the core material made of the hard synthetic resin can be changed as necessary and the thickness of a head portion of the core material can be increased.

In the extrusion molded product of this invention constituted as described above, the core material made of the hard synthetic resin is made remarkably light in weight in comparison with the conventional metallic core material, and does not produce corrosion such as rust, which achieves an effect of sufficiently providing recycling property.

Since the pushed-in portion is formed integrally with the inner or outer peripheral coating body so as to extend downward beyond the end portion of the core material and the holding element is formed in the outer periphery of the pushed-in portion, the extrusion molding of the pushed-in portion having holding element can easily performed. By pushing the pushed-in portion onto the inner peripheral surface having a substantially U-shaped cross section, a gap to mount the molded product body to a flange portion in a vehicle body opening of an automobile can be made remarkably small, so that the holding element of the extrusion molded product can be fixed firmly on the flange portion.

In case that the care material made of the hard synthetic resin and the coating covering body made of the soft synthetic resin are manufactured of a synthetic resin of the same kind, there is achieved an effect that the soft synthetic resin in a molten state is melting adhered to the core material of the hard synthetic resin firmly by means of heat and pressure at the time of extrusion molding.

Since the core material is made of a hard synthetic resin, the thickness of the core material can be changed as necessary. In particular, the increase in thickness of a part of the head portion of the core material achieves an effect that the tensile strength is increased and extrusion molding is performed easily.

### BRIEF DESCRIPTION OF THE DRAWINGS

FIG. 1 is a sectional view of an extrusion molded product in which inner and outer coating bodies made of a soft synthetic resin is attached to a core material made of a hard synthetic resin according to the present invention;

FIG. 2 is a sectional view of an extrusion molded product illustrated in FIG. 1 showing a state in which a pushed-in portion is pushed toward an internal surface;

FIG. 3 is a sectional view of an extrusion molded product according to another embodiment of the present invention;

FIG. 4 is a sectional view of an extrusion molded product illustrated in FIG. 3 showing a state in which a pushed-in portion is pushed toward an internal surface;

FIG. 5 is a sectional view of an extrusion molded product according to still another embodiment in which is provided with holding elements on an inner peripheral coating body;

FIG. 6 is a sectional view of an extrusion molded product illustrated in FIG. 6 showing a state in which a pushed-in portion is pushed toward an internal surface;

FIG. 7 is a sectional view showing of an extrusion molded product according to still another embodiment which is provided with pushed-in portions in both sides of an inner peripheral coating body;

FIG. 8 is a sectional view of an extrusion molded product illustrated in FIG. 7 showing a state of use in which pushed-in portions are pushed toward an internal surface;

FIG. 9 is a sectional view of an extrusion molded product according to still another embodiment which is provided with a pushed-in portion extending from both sides of an inner peripheral coating body to a shape expanded into a circular shape;

FIG. 10 is a sectional view of an extrusion molded product illustrated in FIG. 9 showing a state of use in which the pushed-in portion is pushed toward an internal surface;

FIG. 11 is a perspective view of a core material made of a hard synthetic resin which has cut portions formed in both sides at continuous intervals;

FIG. 12 is a perspective view of a core material according to another embodiment which has cut portions formed in both sides at discontinuous intervals;

FIG. 13 is a perspective view of a core material according to still another embodiment which has cut portions formed alternately in both sides;

FIG. 14 is a perspective view of a core material according to still another embodiment which has but portions formed alternately in both side as grooves;

FIG. 15 is a perspective view of a core material according to still another embodiment which is provided with a thick portion in a head portion of said core material;

FIG. 16 is a sectional view of a conventional extrusion molded product showing a state in which the conventional extrusion molded product is mounted on a flange portion of a vehicle body panel; and

FIG. 17 is an illustrative view showing a process for manufacturing an extrusion molded product according to the present invention.

### DESCRIPTION OF THE PREFERRED CMBODIMENTS

An extrusion molded product which is used in a vehicle body opening of an automobile comprises a molded product body denoted by reference numeral 1, said molded product body 1 includes a core material 2 made of a hard synthetic resin and having a U shape in the cross section, and an outer peripheral coating body 3 made of a soft synthetic resin and attached to the outer periphery of the core material 2, and an inner peripheral coating body 4 made of a soft synthetic resin and attached to the inner peripheral of the core material 2. The inner peripheral coating body 4 is formed integrally with aid outer peripheral coating body 3 so as to cover the core material 2. The outer peripheral coating body 3 or inner peripheral coating body 4 is provided with a pushed-in portion 6 extending downward beyond the end portion 9 of the core material 2 and said pushed-in portion 6 is provided with holding elements 7 in the outer periphery. When the pushed-in portion is bent and pushed toward an inner peripheral surface 20 as shown in FIGS. 2, 4, 6 and 8, the holding elements 7 formed in the outer periphery of the pushed-in portion 6 are opposed to each other or to the inner peripheral coating body 4 to form a narrow gap A, and thereby the extrusion molded product is supported and attached firmly to a flange portion of a vehicle body opening such as a door, trunk, window of automotive by inserting said flange portion into the gap A.

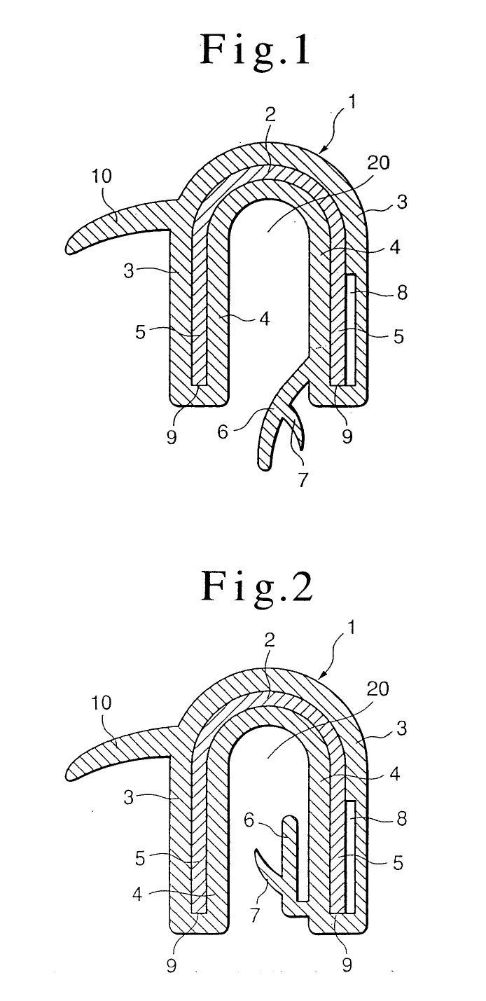

The present invention will be described with reference to the embodiments shown in the accompanying drawings. FIG. 1 shows the molded product body 1 which comprises a core material 2 formed by extrusion molding a hard synthetic resin in the lengthwise direction and having a substantially U-shaped cross section, and an outer peripheral coating body 3 and inner peripheral covering body 4 made of a soft synthetic resin and attached to the core material 2 so as to cover or melting adhere the whole or a part of the core material 2.

A pushed-in portion 6 is formed integrally on the inner peripheral coating body 4 which is disposed on one side 5 of the opposed sides of the core material 2 so as to extend beyond a lower end portion 9 of the core material 2 in the lower direction, and has a holding element 7 formed in the outer periphery. The number of the holding element 7 may be single or plural. The outer peripheral coating body 3 is provided with a space portion 8 which is not melting adhered the core material 2

FIG. 2 shows a state in which the molded product body 1 shown in FIG. 1 is mounted on a flange portion 19 of a vehicle body panel 18 shown in FIG. 16, and which the pushed-in portion 6 is pushed toward the inner peripheral surface 20 on the inside of the core material 2. Reference numeral 10 denotes a decorative lip.

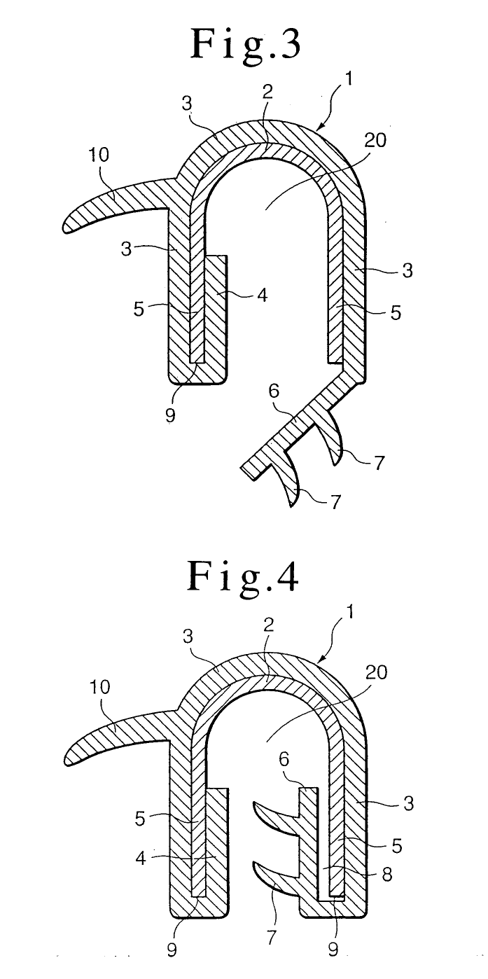

In an embodiment shown in FIG. 3, an outer peripheral coating body 3 is melting adhered to the entire of the outer periphery of the core material 2, and a short inner peripheral coating body 4 is melting adhered to a part of the inner periphery of the core material 2 so as to contact with the outer peripheral coating 3 at the lower end portion 9 of the core material 2. On the other side 5 of the core material 2, a pushed-in portion 6 is formed integrally on the outer peripheral coating body 3 so as to extend downward beyond the lower end portion 9 of the core material 2 and has holding elements 7, 7 formed in the outer periphery.

FIG. 4 shows a state in which the molded product body 1 shown in FIG. 3 is mounted on the flange portion 19 of the opening, i.e. the pushed portion 6 is pushed toward the inner peripheral surface 20 on the inside of the core material 2.

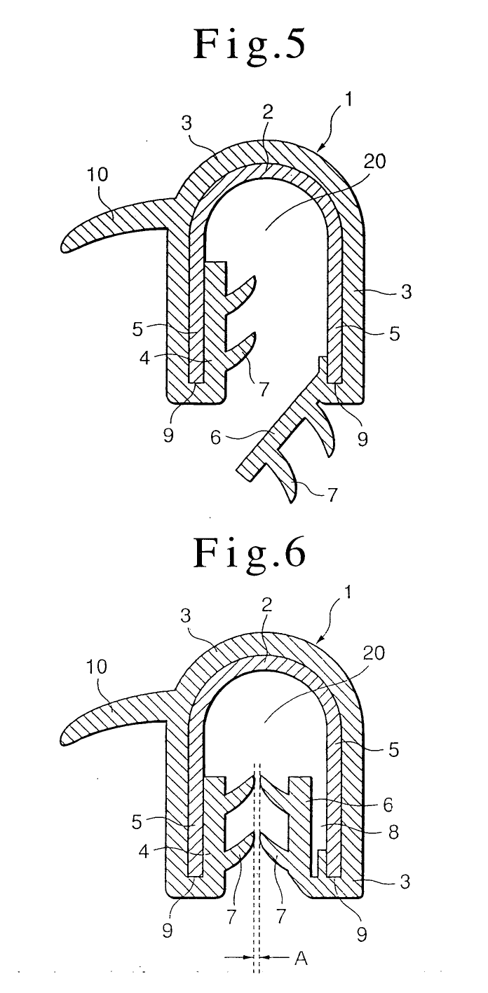

In another embodiment shown in FIG. 5, the outer peripheral coating body 3 is attached to the whole of the outer periphery of the core material 2, and a very short inner peripheral coating body 4 is attached to a part of the inner periphery on one side 5 of the opposed sides 5, 5 of the core material 2 having a substantially U-shaped cross section, and is connected with the outer peripheral coating body 3 at the lower end portion 9 of the core material 2. A pushed-in portion 6 is formed integrally on the very short inner peripheral coating body 4 so as to extend downward from the connected point with the outer peripheral coating body and is provided with holding elements 7, 7 formed in the outer periphery thereof. On the other side 5 of the core material 2, a short inner peripheral coating body 4 is attached to a part of the inner periphery of the core material 2 so as to connect with the outer peripheral coating body 3 at the lower end portion 9 of the core material 2 and is provided with holding elements 7, 7 protruded directly from the inner peripheral coating body 4 toward the inner peripheral surface 20.

FIG. 6 shows a state in which the molded product body 1 is mounted on the flange portion 19 of the opening of a vehicle body, i.e. the pushed-in portion 6 is pushed toward the inner peripheral surface 20 of the core material 2. A space portion 8 substantially in a contact state is formed between the pushed-in portion 6 and the side 5 of the core material 2, and narrow gap A is also formed between the holding elements 7 and 7. Sometimes, the holding elements 7, 7 are in a contact state to each other. Thereby, the molded product body 1 of this embodiment can be supported firmly to the flange portion 19.

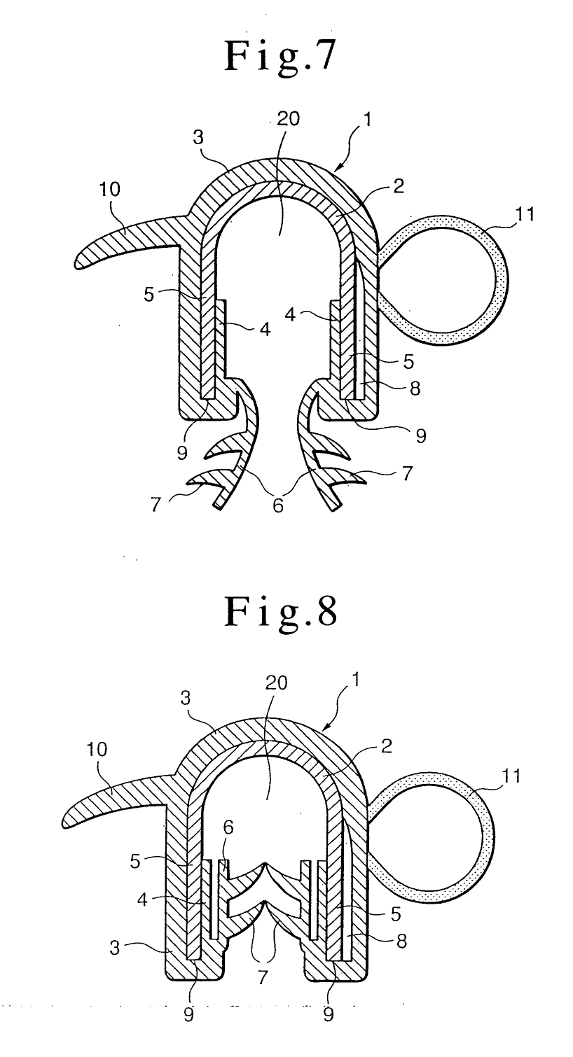

In still another embodiment shown in FIG. 7, the molded product body 1 is constituted so that the core material 2 made of the hard synthetic resin and having a substantially U-shaped cross section is provided with the outer peripheral covering body 3 made of the soft synthetic resin and melting adhered to a part of the outer periphery of the core material 2 and short inner peripheral covering bodies 4, 4 made of the soft synthetic resin and formed on each part of both of the opposed sides 5, 5 of the core material 2 so as to extend integrally with the outer peripheral coating body 3. The short inner peripheral coating bodies 4, 4 are provided with each of the pushed-in portion 6 extended downward beyond the lower end portion 9 of the core material 2. Each pushed-in portion 6 has the holding elements 7, 7 formed at required positions of the outer periphery. A space portion 8 is formed in a portion that is not melting adhered between the inner periphery of the outer peripheral coating body 3 and the outer periphery of the core material 2.

FIG. 8 shows a state in which the pushed-in portions 6, 6 having the holding elements 7, 7, of the molded product body 1 shown in FIG. 7 are pushed toward the inner peripheral surface 20 on the inside of the core 2. Reference numeral 11 denotes a hollow seal portion mounted to required position of the outer peripheral covering body 3.

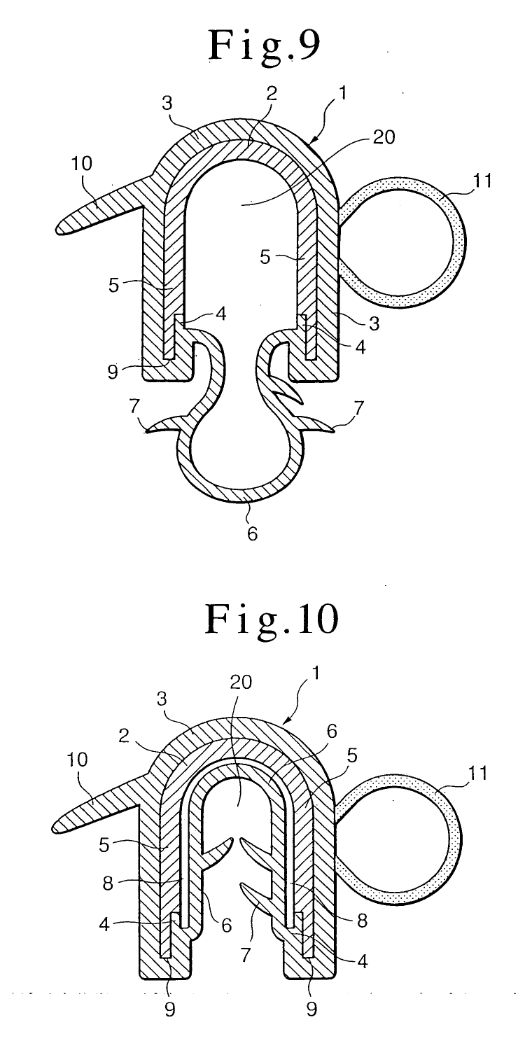

In still another embodiment shown in FIG. 9, the molded product body 1 is constituted so that the core material 2 is provided with the outer peripheral coating body 3, 3 attached to the entire of the outer periphery of the core material 2 and the short inner peripheral coating bodies 4, 4 attached to each part on both of the opposed sides 5, 5 of the core material 2 and formed integrally with the outer periphery coating body 3. A curved line shaped pushed-in portion 6 is formed so as to extend downward from the inner peripheral coating bodies 4, 4 and to connect the short inner peripheral coating bodies 4, 4 to each other. The curved line shaped pushed-in portion 6 is provided with the required number of holding elements 7, 7 in the required position. In some cases, a curved line shaped pushed-in portion 6, can be formed so as to extend downward from the outer peripheral coating bodies 3, 3 and to connect the lower ends of the outer peripheral covering body 3, 3 to each other, although not shown. The lower end portion 9, 9 of the opposed sides 5, 5 of the core material 2 has a thin portion to embed the inner peripheral coating body 4.

FIG. 10 shows a state in which the molded product body 1 shown in FIG. 9 is mounted on the flange portion 19 of the vehicle body panel 18. In this embodiment, when the pushed-in portion 6 is pushed toward the inner peripheral surface 20 of the core material 2, the curved line shaped pushed-in portion 6 is positioned in such state that the inner peripheral surface of the pushed-in portion 6 do not contact with the inner peripheral surface of the core material 2 and thus a space portion 8 is formed.

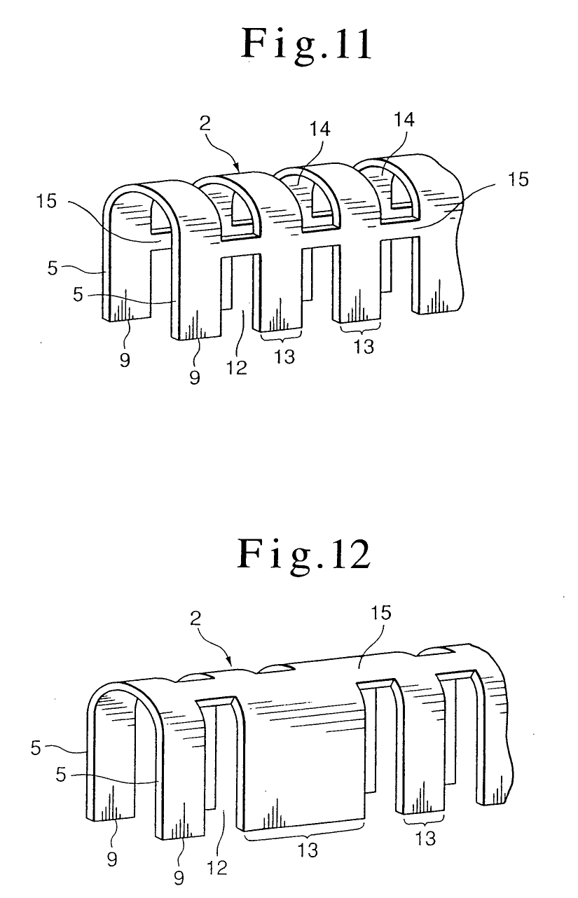

FIG. 11 shows an embodiment of a core material 2 which is made of a hard synthetic resin and is inserted in the interior of the molded product body 1, said core material 2 is formed into a substantially U shape in cross section and is provided with cut portions 12, 12 and upper cut portions 14, 14 punched with connecting portions 15, 15 and interval portions 13, 13 being left. The cut portions 12, 12 are formed in the opposed sides 5, 5 of the core material 2 and the cut portions 14, 14 are formed in a head portion at the upper part of the core material 2. The interval portions 15, 15 of the core material 2 are connected to each other by the connecting portions 15, 15 which separate the side cut portions 12, 12 and the upper cut portions 14, 14.

FIG. 12 shows another embodiment of the core material 2, in which the core material 2 is formed by punching the cut portions 12, 12 in a state in which discontinuous interval portions 13, 13 are formed in the opposed sides 5, 5 with the connecting portion 15 being left at the upper part.

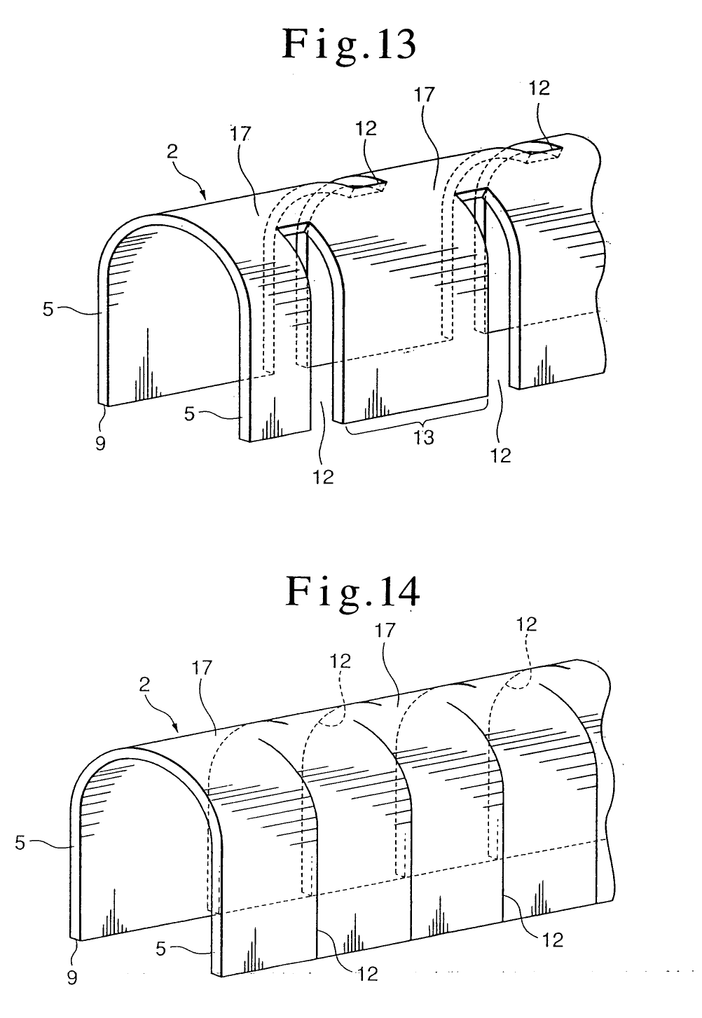

FIG. 13 shows still another embodiment of the core material 2 in which the core material 2 having a substantially U-shaped cross section is formed with the opposed sides 5, 5 and a head portion 17. The cut portions 12, 12 are formed on one side 5 by cutting the side 5 toward the head portion 17 at the upper part, and the cut portions 12, 12 are formed on the other of the side 5 by cutting the side 5 in the same way toward the head portion 17. The cut portions 12, 12 are formed continuously or discontinuously on the sided 5, 5 so that the opposed cut portions 12, 12 on both sides 5, 5 are positioned alternately at the predetermined intervals.

FIG. 14 shows still another embodiment of the core 2 having a substantially U-shaped cross section in which slit shaped cut portions 12, 12 are formed on the opposed sides 5, 5 toward the head portion 17. The cut portions 12, 12 are formed so that the cut portions disposed on one of the sides 5, 5 and the cut portions 12, 12 disposed on the other of the sides 5, 5 are arranged alternately.

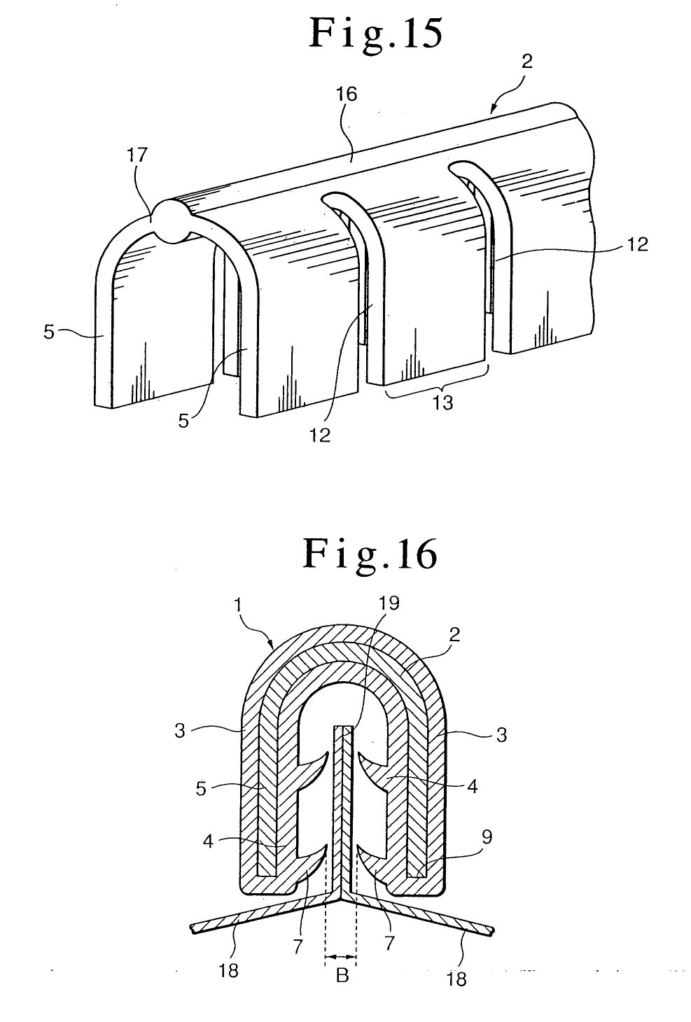

FIG. 15 shows still another embodiment of the core material 2, which is made of the hard synthetic resin and has a substantially U-shaped cross section, said core material 2 is provided with a thick portion 16 formed by increasing the thickness of a part of the head portion 17. The thick portion 16 is formed by increasing the thickness on the outer peripheral surface side or the inner peripheral surface side of the core 2, but the thickness of either of both sides of the inner and outer peripheral surfaces may be increased.

FIG. 16 shows a state in which the molded product body 1 formed by the prior art is mounted on the flange portion 19 of the vehicle body panel 18. The conventional molded product body 1 comprises the core material 2 of the substantially U-shaped cross section covered by the outer peripheral coating body 3 and the inner peripheral coating body 4, and the opposed holding elements 7, 7 are formed on the inner peripheral covering body 4, 4 positioned on the opposed sides 5, 5. In this case, a gap B between the opposed holding elements 7, 7 is remarkably wide, so that there arises a problem in that the molded product body 1 easily comes off when being mounted on the flange portion 19 of the vehicle body opening.

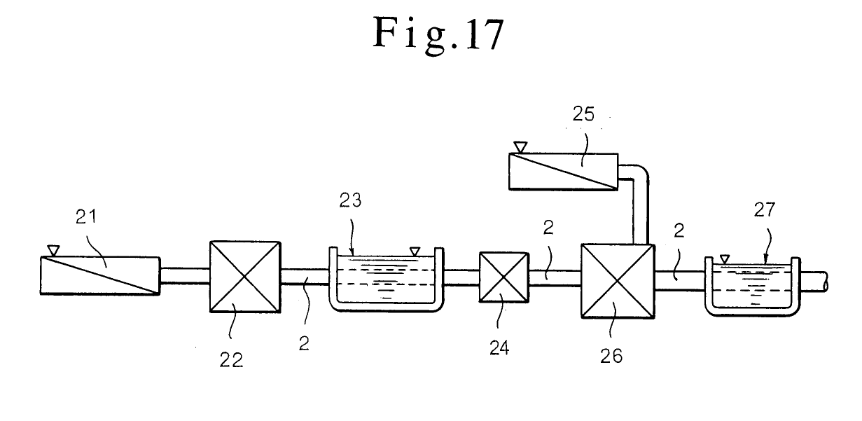

FIG. 17 shows a manufacturing process in which extrusion molding of the core material 2 of the present invention and extrusion molding of the coating bodies 3, 4 are performed continuously. The core material 2 is extrusion molded by a first extrusion molding machine 21 into which a hard synthetic resin is poured during the time passing through the interior of a first die 22, and the core material 2 having a substantially U-shaped cross section is formed and passes through a cooling layer 23. Thereafter the cut portions 12, 12 are formed by a punching machine 24 on the core material 2 of the U-shaped cross section. Subsequently the core material 2 having the cut portions 12, 12 enters a second die 26, where the outer and inner peripheral surfaces of the core material 2 are coated with a soft synthetic resin poured by a second extrusion molding machine 25. The coating bodies 3, 4 are melting adhered to the core material 2 by the soft synthetic resin in a molten state, and the pushed-in portion 6 is formed by integrally with extending the inner or outer coating body. After the holding elements 7, 7 are extrusion molded integrally at the outer periphery of the pushed-in portion 6, the molded product body 1 is sent out after passing through a cooling tank 27.

In the above-mentioned manufacturing method, the soft synthetic resin forming the pushed-in portion 6 and the holding element 7 and the inner and outer coating bodies 3, 4 are manufactured of the same material using one extrusion molding machine. In the case where the hardness or kind of material for the pushed portion 6 and the holding element 7 is changed according to the function and quality thereof, multiple extrusion moldings are performed in the second die 26 by using the second and third extrusion molding machines.

The materials used in the present invention are explained. As the hard synthetic resin forming the core material 2 having a substantially U-shaped cross section, an olefin resin such as polypropylene and polyethylene, styrene resin, nylon resin, polyester resin, polycarbonate resin, or a mixed synthetic resin in which powder of talc, mica, glass fiber, etc. is mixed with the aforementioned hard synthetic resin is used. The mixed synthetic resin achieves an effect of enhancing the stiffness and heat resistance of hard synthetic resin forming the core material 2 and decreasing the coefficient of linear thermal expansion thereof.

As the soft synthetic resin forming the coating body, an olefin resin or styrene resin having a hardness not higher than HDA90 (JIS K7215) or a thermoplastic elastomer thereof is used.

1. An extrusion molded product which is mounted in various opening portions of a vehicle body, such as an automotive door, trunk, and window, comprising;
a core material made of a hard synthetic resin and having a substantially U-shaped cross section;
an outer peripheral coating body made of a soft synthetic and coating the outer peripheral of the core material;
an inner peripheral coating body made of a soft synthetic resin and coating the inner peripheral of the core material;
a pushed-in portion formed integrally with said coating body and extending downward beyond the lower end of the core material so as to be able to be pushed toward an inner peripheral surface of the core material; and
a holding element formed in the outer periphery of said pushed-in portion.

2. The extrusion molded product according to claim 1, wherein said outer peripheral coating body is melting adhered to the whole or a part of the outer peripheral surface of the core material having a substantially U-shaped cross section.

3. The extrusion molded product according to claim 1, wherein said inner peripheral coating body is coated and melting adhered to the whole or a part of the inner peripheral surface of the core material having a substantially U-shaped cross section.

4. The extrusion molded product according to claim 1, wherein the pushed-in portion is formed integrally with the outer peripheral coating body or the inner peripheral coating body on one side of the opposed sides of the core material 2 having the substantially U-shaped cross section so as to extend downward beyond the lower end of the core material, said pushed-in portion 6 is provided with a holding element at the outer periphery thereof, and a holding element is formed integrally with the inner peripheral coating body on the other side of the opposed sides of the core material.

5. The extrusion molded product according to claim 1, wherein the pushed-in portion is formed integrally with the inner peripheral coating body on one side of the opposed sides of the core material having the substantially U-shaped cross section so as to extend downward beyond the lower end of the core material, said pushed-in portion is provided with holding elements at the outer periphery thereof, and the pushed-in portion 6 is formed integrally with the inner peripheral coating body on the other side of the opposed sides of the core material so as to extend downward beyond a lower end portion 9 of the core material, and is provided with a holding element at the outer periphery thereof.

6. The extrusion molded product according to claim 1, wherein a curved line shaped pushed portion is formed integrally with the inner peripheral coating body on both of the opposed sides of the core material having the substantially U-shaped cross section so as to extend downward and to connect the inner peripheral coating body on both of the opposed sides to each other, and said pushed portion is provided with a plurality of holding elements at the outer periphery thereof.

7. The extrusion molded product according to claim 1, wherein a thick portion is formed by increasing the thickness of the core material on a part of a head portion of the core material.

8. The extrusion molded product according to claim 2, wherein the pushed-in portion is formed integrally with the outer peripheral coating body or the inner peripheral coating body on one side of the opposed sides of the core material 2 having the substantially U-shaped cross section so as to extend downward beyond the lower end of the core material, said pushed-in portion 6 is provided with a holding element at the outer periphery thereof, and a holding element is formed integrally with the inner peripheral coating body on the other side of the opposed sides of the core material.

9. The extrusion molded product according to claim 3, wherein the pushed-in portion is formed integrally with the outer peripheral coating body or the inner peripheral coating body on one side of the opposed sides of the core material 2 having the substantially U-shaped cross section so as to extend downward beyond the lower end of the core material, said pushed-in portion 6 is provided with a holding element at the outer periphery thereof, and a holding element is formed integrally with the inner peripheral coating body on the other side of the opposed sides of the core material.

10. The extrusion molded product according to claim 2, wherein the pushed-in portion is formed integrally with the inner peripheral coating body on one side of the opposed sides of the core material having the substantially U-shaped cross section so as to extend downward beyond the lower end of the core material, said pushed-in portion is provided with holding elements at the outer periphery thereof, and the pushed-in portion 6 is formed integrally with the inner peripheral coating body on the other side of the opposed sides of the core material so as to extend downward beyond a lower end portion 9 of the core material, and is provided with a holding element at the outer periphery thereof.

11. The extrusion molded product according to claim 3, wherein the pushed-in portion is formed integrally with the inner peripheral coating body on one side of the opposed sides of the core material having the substantially U-shaped cross section so as to extend downward beyond the lower end of the core material, said pushed-in portion is provided with holding elements at the outer periphery thereof, and the pushed-in portion 6 is formed integrally with the inner peripheral coating body on the other side of the opposed sides of the core material so as to extend downward beyond a lower end portion 9 of the core material, and is provided with a holding element at the outer periphery thereof.

12. The extrusion molded product according to claim 2, wherein a curved line shaped pushed portion is formed integrally with the inner peripheral coating body on both of the opposed sides of the core material having the substantially U-shaped cross section so as to extend downward and to connect the inner peripheral coating body on both of the opposed sides to each other, and said pushed portion is provided with a plurality of holding elements at the outer periphery thereof.

13. The extrusion molded product according to claim 3, wherein a curved line shaped pushed portion is formed integrally with the inner peripheral coating body on both of the opposed sides of the core material having the substantially U-shaped cross section so as to extend downward and to connect the inner peripheral coating body on both of the opposed sides to each other, and said pushed portion is provided with a plurality of holding elements at the outer periphery thereof.

14. The extrusion molded product according to claim 2, wherein a thick portion is formed by increasing the thickness of the core material on a part of a head portion of the core material.

15. The extrusion molded product according to claim 3, wherein a thick portion is formed by increasing the thickness of the core material on a part of a head portion of the core material.

16. The extrusion molded product according to claim 4, wherein a thick portion is formed by increasing the thickness of the core material on a part of a head portion of the core material.

17. The extrusion molded product according to claim 5, wherein a thick portion is formed by increasing the thickness of the core material on a part of a head portion of the core material.

18. The extrusion molded product according to claim 6, wherein a thick portion is formed by increasing the thickness of the core material on a part of a head portion of the core material.
